(19) United States
(12) Patent Application Publication
(10) Pub. No.: US 2025/0347644 A1
(43) Pub. Date: Nov. 13, 2025

(54) HIGH THROUGHPUT, THERMO-REFLECTANCE MICROSCOPY TO MEASURE THERMAL TRANSPORT AT THE MICROSCOPIC SCALE

(71) Applicant: Brigham Young University, Provo, UT (US)

(72) Inventors: Troy Munro, Orem, UT (US); Santiago Gomez Paz, Provo, UT (US); Alexander Hansen, Provo, UT (US)

(21) Appl. No.: 18/860,200

(22) PCT Filed: Apr. 27, 2023
(86) PCT No.: PCT/US2023/020273

§ 371 Date: Oct. 25, 2024

Related U.S. Application Data
(60) Provisional application No. 63/336,711, filed on Apr. 29, 2022.

(51) Int. Cl. G01N 25/18

(52) U.S. Cl. CPC G01N 25/18

(57) ABSTRACT

Embodiments disclosed herein relate to methods and systems for determining thermal properties of materials by using frequency modulated pump light intensity to cyclically heat a sample, and using probe light to induce reflected light from reflective materials on the surface of the material during the cyclic heating. The pump and probe light may be emitted onto a plurality of locations on a material sample simultaneously. The methods and systems utilize the phase delay between the frequency modulated pump light and the corresponding reflected light to determine the thermal properties of the material at a plurality of the locations on the material sample simultaneously.

### CROSS-REFERENCE TO RELATED APPLICATIONS

This application claims priority to U.S. Provisional Application No. 63/336,711 filed on 29 Apr. 2022, the disclosure of the foregoing application is incorporated herein in its entirety by this reference.

### BACKGROUND

Materials tend to degrade over time. Some materials may be intended to be, or may originally be, substantially homogenous. Due to one or more conditions or processes, such as oxidation, reduction, radiation, dissolution, phase separation, welding, sintering, hydration, etc., the homogenous material may degrade and lose homogeneity to include one or more degradation or defect products therein. Information about the degradation may indicate the useful life or quality of the homogenous material, as the material properties change as material defects are present.

### SUMMARY

Embodiments disclosed herein relate to methods and systems for determining thermal properties of materials by using frequency modulated pump light, fixed intensity probe light, and reflective indicators. In an embodiment, a method for determining a thermal property of one or more portions of a material sample is disclosed. The method includes (a) illuminating the surface of the material sample having a reflective material disposed thereon with pump light from a pump light source and probe light from probe light source at a plurality of locations on the surface. The method includes (b) modulating an intensity of the pump light at an initial modulation frequency. The method includes (c) detecting reflected light signals from the reflective material at a photodetector, over a duration, responsive to reflected light induced via the probe light from the probe light source. The method includes (d) altering the initial modulation frequency of the pump light to an altered modulation frequency. The method includes (e) performing acts (a)-(d) at the altered modulation frequency. The method includes (f) determining the thermal property at least partially based on the reflected light. The method may include determining physical properties of the material based at least on the thermal properties.

In an embodiment, a system for determining a thermal property of a material sample is disclosed. The system includes an optical arrangement including a pump light source, a probe light source, and a photodetector, wherein the probe light source is configured to emit probe light and the pump light source is configured to emit pump light. The system includes at least one controller operably coupled to the optical arrangement, wherein the controller is configured to direct the probe light source to emit the probe light; direct the pump light source to emit the pump light and modulate an intensity of the pump light according to a selected frequency; receive electrical signals from the photodetector corresponding to reflected light detected at the photodetector; and determine the thermal property at least partially based on the reflected light detected at the photodetector. In an embodiment, the system may include a supercomputer in electronic communication with the optical arrangement, such as with the controller.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1 is a flow chart of a method for determining a thermal property of one or more portions of a material sample, according to an embodiment.

FIG. 2 is a graph of pump light intensity and reflected light intensity versus time, according to an embodiment.

FIG. 3 is a graph of the voltage intensity of pump light and corresponding alternating current (AC) portion of voltage intensity of the reflected light versus time, according to an embodiment.

FIG. 4A is a graph of the fast Fourier transform (“FFT”) magnitude of the voltage intensity of the pump light and the voltage intensity of the reflected light versus frequency, according to an embodiment.

FIG. 4B is a graph of the FFT amplitude of the voltage intensity of the pump light and the FFT frequency of the voltage intensity of the reflected light, according to an embodiment.

FIG. 5 is a graph of the phases of the FFT pattern of the voltage intensity of the reflected light and the FFT pattern of the voltage intensity of the pump light, versus the frequencies determined by the FFT, according to an embodiment.

FIG. 6 is an illustration of a pattern that may be projected from the probe light source onto the surface of the material at a plurality of locations and the correspondingly measured amplitude image that may be collected by the lock-in camera, according to an embodiment.

FIG. 7 is a graph of the coefficient of thermoreflectance for metals that may be disposed as the reflective material on a surface of the material sample, according to an embodiment.

FIG. 8A is an illustration of a thermal contact interface at a grain boundary between two grains, according to an embodiment.

FIG. 8B is an illustration of the thermal contact interface of the two grains of FIG. 8A with a thermal wave spreading therethrough and the corresponding phase delay graph, according to an embodiment.

FIG. 9 is an illustration of an optical arrangement, according to an embodiment.

FIG. 10 is a block diagram of a layout of components for an optical arrangement and path of laser light used for PSDTR, according to an embodiment.

FIG. 11 is photographs of a system containing components of the optical arrangements disclosed herein, according to an embodiment.

FIG. 12 is a block diagram of a sample pipeline with 4 stages, according to an embodiment.

FIG. 13 is a schematic of a controller for executing any of the embodiments of methods disclosed herein, according to an embodiment.

### DETAILED DESCRIPTION

Embodiments disclosed herein relate to parallelized spatial domain thermoreflectance (PSDTR) methods and systems for determining thermal properties of material samples. Different materials diffuse heat at different rates. The thermal conductivity and diffusivity of a material may be characteristic of a composition of the material itself. Information about a homogeneity of the material can be determined by examining the heat diffusion rate(s) of the material. The information may be used to identify grain boundaries or discontinuities in materials. By studying material homogeneity or lack thereof, much can be learned about the materials and their use, such as formation of degradation products or differences in materials (e.g., trees, polymers, metals such as nuclear fuels or shielding, sintered ceramics, composites, functionally graded materials, etc.).

The methods and systems disclosed herein utilize the photothermal effect using thermal waves generated by cyclically (e.g., sinusoidally) varying pump light delivered to an area of a material sample. As this irradiated area is cyclically heated, the thermal properties of the material may be determined. For example, the thermal wave may experience both an attenuation and phase delay that are functions of the material's properties (e.g., grain boundaries, material species, defects, or the like), the distance from the modulated source, and the modulation frequency.

The PSDTR techniques disclosed herein utilizes a laser projector using digital light process (DLP) technology to illuminate many (e.g., dozens or more) sites on a material sample, such as grains and boundaries, simultaneously and perform spatial domain thermoreflectance (SDTR) measurements at each site simultaneously. A thin reflective film (e.g., nanometer-thick gold film) is applied to the surface of the material to act as a thermal transducer to measure the relative temperature changes of the surface. These changes are picked up in reflected probe light by a photodetector (e.g., lock-in camera, LIC). A plurality of points may be examined simultaneously utilizing the PSDTR techniques and systems disclosed herein.

By utilizing a parallel architecture rather than a serial architecture, the throughput of characterization of a material may be reduced by 1-2 orders of magnitude, shortening characterization of a million locations from years to 1-2 weeks. The thermal conductivity microscope (TCM, used to measure nuclear fuel using thermoreflectance methods) at Idaho National Laboratory, INL, has a typical an acquisition time of 10 minutes for one location. At best, this would require almost 2 years (694 days) of rastering the laser beams over the surface constantly for 24 hours, 7 days a week to measure 100,000 locations. Additionally, the measurement procedure is not autonomous and requires a researcher to constantly be attentive to the instrument. By parallelizing the measurement using the proposed approach of projecting images of large numbers of (e.g., about 100) pump and probe spots simultaneously, this can be shortened to a single week (170 hours, also assuming 10-minute acquisition times for each set of images).

The PSDTR techniques disclosed herein provide high throughput thermal characterization of materials. Because of the wide use of polycrystalline material in electronics management, nuclear power generation, and other industries, the techniques and systems disclosed herein make acquiring the data at the microscopic level needed to design materials with improved thermal management capabilities reasonably accessible.

The thermoreflectance based techniques disclosed herein periodically modulate the intensity of the pump light (e.g., pump heating laser) and record the corresponding phase delayed temperature change of the irradiated (e.g., heated) area, by observing reflected probe light (e.g., color light beam). The probe light is shone on the irradiated area and reflected from the reflective material applied to the sample surface. The thermal conductivity and diffusivity of the material in the irradiated area can be determined by examining the modulation of the reflected light and comparing the same to the modulation of the heating laser. Differences in thermal conductivity and diffusivity from location to location on the sample, as observed via the reflections of the probe light, can indicate that different materials are present in the sample.

The methods and systems disclosed herein employ an algorithm for determining thermal conductivity, thermal diffusivity, and Kapitza resistance (Rₖ) at grain boundaries of a material by examining the reflected probe light while modulating heat applied to the sample with the pump light. The algorithm compares the modulation of the pump light (e.g., laser) emitted to a location and the correspondingly modulated pattern of the reflected light signals detected from the reflective coating on the material surface in the locations responsive to a probe light (that is not modulated) shone on the locations, to determine a phase delay therebetween. The acts are repeated at different pump light frequencies. The algorithm uses the phase delays and amplitudes determined at the different modulation frequencies to solve for the thermal conductivity and diffusivity of the material sample at a specific location. The thermal conductivity and diffusivity can be used to determine if the material sample has material inconsistencies therein, such as grain boundaries, cracks, material impurities, or the like. By studying such material inconsistencies, much can be learned about the materials and their use, such as formation of degradation products or differences in materials (e.g., trees, polymers, ceramics, metals such as nuclear fuels or shielding, etc.). By parallelizing the SDTR characterizations at many different locations simultaneously, the throughput time of the characterizations for a material may be exponentially reduced compared to a serial technique using a single pump and probe.

The thermoreflective techniques disclosed herein are used in combination with computer program including an algorithm that analyzes the data from each probe spot (e.g., as captured by the lock-in camera) to obtain the thermal conductivity and/or diffusivity of individual grains and the Rₖ of grain boundaries. The algorithm may be run on a plurality of cores of a supercomputer using multiprocessing. The system for performing the PSDTR characterizations disclosed herein may be include a user interface that aligns the digital light process projectors, configures the measurement trajectories based on grain boundary mapping, automates sample focusing and positioning, and segments the results for individual analysis.

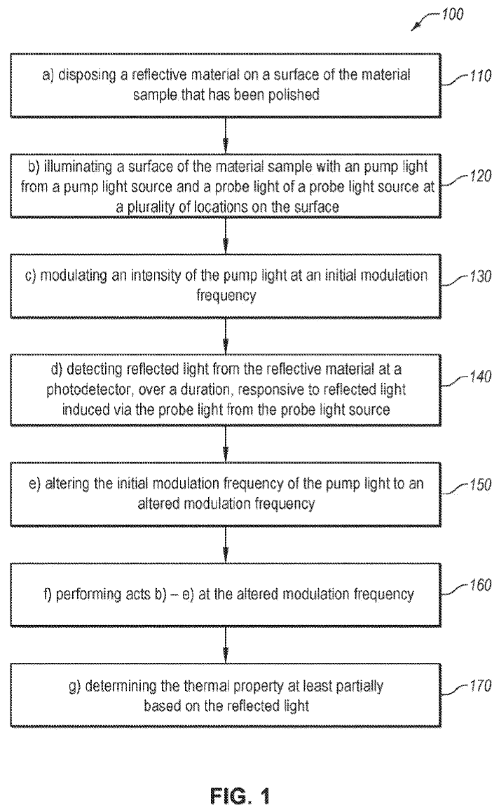

FIG. 1 is a flow chart of a method 100 of determining a thermal property of one or more portions of a material sample, according to an embodiment. The method 100 includes the act 110 of (a) disposing a reflective material on a polished surface of the material sample. The method 100 includes the act 120 of (b) illuminating the surface of the material sample with pump light from a pump light source and probe light from probe light source at a plurality of locations on the surface. The method 100 includes the act 130 of (c) modulating an intensity of the pump light at an initial modulation frequency. The method 100 includes the act 140 of (d) detecting reflected light signals from the reflective material at a photodetector, over a duration, responsive to reflected light induced via the probe light from the probe light source. The method 100 includes the act 150 of (e) altering the initial modulation frequency of the pump light to an altered modulation frequency. The method 100 includes the act 160 of (f) performing (b)-(e) at the altered modulation frequency. The method 100 includes the act 170 of (g) determining the thermal property partially based on the reflected probe light. In embodiments, one or more of the acts 110-170 may be combined, omitted, split into multiple acts, or performed in a different order. For example, the act 110 may be omitted if the material sample already has the reflective material thereon. In some embodiments, the acts 120 and 130 may be performed in a single act. In some embodiments, additional acts may be included in the method 100.

The method 100 includes the act 110 of (a) disposing a reflective material on a surface of the material sample. In some embodiments, disposing the reflective material on a surface of the material sample may include disposing a reflective material that reflects light responsive to irradiation with probe light. The material sample may include one or more of wood(s), metal(s), polymer(s), ceramic(s), composite(s), etc. For example, disposing the reflective material on a polished surface of the material sample may include disposing the reflective material on a radioactive fuel sample, such as a portion or cross-section of an at least partially spent nuclear fuel rod, pellet, or the like.

In some embodiments, the reflective material may include a metal film, such as a file of one or more of gold, titanium, nickel, aluminum, silver, platinum, tantalum, ruthenium, vanadium, niobium, rhenium, tungsten, cobalt, palladium, molybdenum, bismuth, zirconium, or chromium. In some embodiments, the reflective material includes a coating or film on the material sample. The coating may be nanometers thick (1-200 nm, 1-100 nm, or the like) or thicker. The reflected light is temperature dependent, as determined by the coefficient of thermoreflectance of the reflective material.

In some embodiments, disposing the reflective material on a polished surface of the material sample may include physical or chemical deposition on the polished surface of the material sample with the reflective material. For example, disposing a reflective material on the polished surface of the material sample may include physical deposition, such as by thermal evaporation, electron beam deposition, plasma sputter coating, etc., of the reflective material to the material sample. For example, disposing a reflective material on the surface of the material sample may include chemical deposition, such as by vapor deposition from a solution of liquid, gas, etc., of the reflective material to the material sample. Any chemical deposition technique may be used to apply the reflective material.

In some embodiments, disposing the reflective material on the polished surface of the material may include pretreating the surface of the material, such as by one or more of cleaning, polishing, laser etching, or grinding the surface of the material sample.

The method 100 includes the act 120 of (b) illuminating the surface of the material sample with pump light from a pump light source and probe light from probe light sources at a plurality of locations on the surface. In some embodiments, the pump light source may include a light source for heating the material sample, such as an pump laser, color laser, or digital light projector (e.g., red laser from a DLP projector). The pump light source may include a beam splitter, mirror(s), or the like for projecting light onto a plurality of positions on the material sample. For example, illuminating the surface of the material sample with the pump light from the pump light source and the probe light of the probe light source at the initial location on the surface may include illuminating the surface with red light from a DLP projector with a micro-mirror array to project a modulated red laser light to heat the material surface at a plurality of points (e.g., at least tens, hundreds, or thousands of locations).

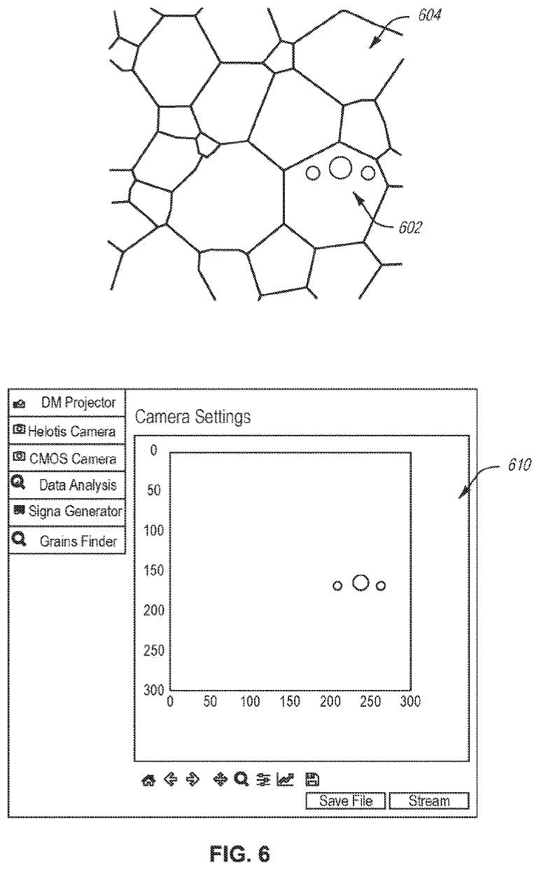

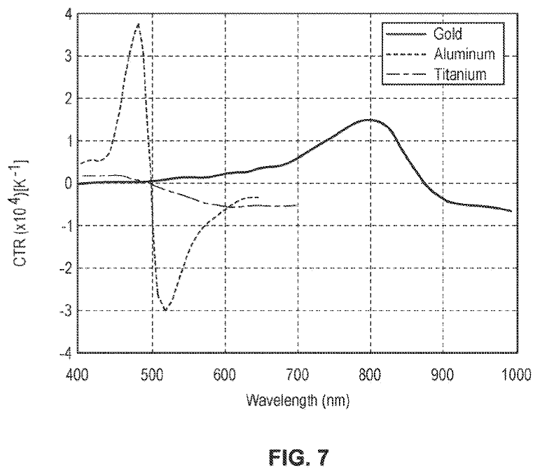

In some embodiments, the probe light source may include a light source for emitting the probe light onto the material sample, such as a color laser, color LED, or DLP projector. For example, illuminating the surface of the material sample with the pump light from the pump light source and the probe light of the probe light source at a plurality of locations on the surface may include illuminating the surface with the color laser or LED where the color is different from the color of the pump light source. The color laser or LED may emit probe light in a selected color (e.g., wavelength(s)), such as blue, green, etc. In some embodiments, the probe light source and the pump light source may be disposed on an optical arrangement as shown in FIGS. 6 and 7 below.

While red pump light and green probe light are used in the examples disclosed herein, other pump light and probe light pairing may be utilized. For example, the wavelength for the pump light and probe light (and the specific colors corresponding thereto) may be selected based on the material of the thin film applied to the material surface so that the reflected light is as sensitive as possible to the variations in temperatures of the material and thin film.

The probe light source may be positioned to emit the probe light at selected distance(s) from the pump light emitted from the pump light source. For example, the probe light source may be positioned, equipped, or otherwise configured to emit probe light at least 10 nm from the corresponding pump light on the surface of the sample, such as at least 0.1 μm, 0.1 μm to 500 μm, 1 μm to 100 μm, at least 100 μm, 100 μm to 500 μm, 500 μm to 1 mm, or less than 1 mm. The distance of the probe light from the pump light may be identical between each pump light and probe light pair on the surface of the material, or may independently differ from pair to pair.

In some embodiments, illuminating the surface of the material sample with the pump light from the pump light source and the probe light of the probe light source at the plurality of locations on the surface may include illuminating the surface of the material sample with pump light at an initial intensity (e.g., and/or frequency) and probe light at a constant (e.g., fixed) frequency. The plurality of locations of the pump light and the probe light may differ from each other, such as by a preselected distance or preselected distances. For example, a single point of pump light may have a plurality of corresponding probe lights at selected distances from the pump light. Such a configuration allows for monitoring of heating characteristics at different distances from a single pump light location.

In some embodiments, illuminating the surface of the material sample with the pump light from the pump light source and the probe light of a probe light source at the plurality of locations on the surface may include illuminating the surface of the material sample with the pump laser and the color laser or LED, wherein the beam of the color laser or LED is emitted at a fixed intensity and is shone at the surface of the material sample such that the pump laser and the color laser or LED patterns are in near proximity to each other at the surface of the material.

The method 100 includes the act 130 of (c) modulating an intensity of the pump light at an initial modulation frequency. Modulating the intensity of the pump light at the initial modulation frequency may include initiating a sinusoidal modulation of the pump radiation (e.g., pump light) emitted from the pump light source. For example, modulating the intensity of the pump light at the initial modulation frequency may include modulating the intensity of the pump light beam in a sinusoidal pattern of increasing and decreasing intensities. Modulating the intensity of the pump light at the initial modulation frequency may be effective to cyclically heat the material sample (and reflective material thereon) in the sinusoidal pattern. Modulating the intensity of the pump light at the initial modulation frequency may be effective to modulate the temperature of the material sample by 25° C. or less (e.g., 15° C., 10° C., 5° C., 3° C., or 1° C.). For example, the initial modulation frequency of the pump light may correspondingly modulate the temperature of the material sample in the illuminated region by 5° C. or less.

The initial frequency of the sinusoidal pattern of modulation may be a lowest frequency, such as at least 1 Hz, or in a range of 100 Hz to 200,000 Hz. In some embodiments, modulating the intensity of the pump light at the initial modulation frequency may include causing the pump light source to modulate the pump light, with a controller. For example, the controller may have programming to cause the pump light source to modulate the pump light at a selected pattern of modulation, such as increasing or decreasing modulation frequencies.

By sinusoidally modulating the intensity of the light, the temperature of the material at the location irradiated responds in an oscillatory manner at the same frequency. This temperature variation is often called a thermal wave, and it experiences both an attenuation and phase delay that are functions of the material's properties and microstructure, the distance from the modulated source, and the modulation frequency. The material heats and cools in a pattern corresponding to the modulation frequency in a delayed manner due to the time it takes for the heat provided by the pump light to diffuse through the material. Changes in the intensity (e.g., as noted by the amplitude and phase of the pattern) of reflected light from the reflective material on the material surface may aid in determining the thermal property (e.g., thermal conductivity or thermal diffusivity) of the material in the irradiated locations. Differences in the same thermal property at different locations on a material sample may indicate that the material sample is non-homogenous (e.g., includes more than one material therein) or the presence of grain boundaries (e.g., a Kapitza resistance, Rₖ, is present). For example, the material sample may contain one or more of metals (e.g., alloys), metal oxides, binder(s), precipitates therein, or hydrides therein. In some embodiments, the sample may include one or more of a TRISO fuel, metallic cladding, sintered ceramic, and one or more degradation products thereof, such as hydrides. By identifying differing thermal properties at different locations, it can be shown that the material in at least one of the locations or sites differs from the material in one or more of the remaining locations or sites.

The method 100 includes the act 140 of (d) detecting reflected light signals from the reflective material at a photodetector, over a duration, responsive to reflected light induced via the probe light from the probe light source. The photodetector may include a lock-in camera or thermal camera. A group or pattern of reflected light induced via the probe light from the probe light source may exhibit a phase delay corresponding to the modulation frequency of the pump light (e.g., pump light). The intensity of the reflected light reflected from the reflective material illuminated on the material sample may be directly related to the temperature of the sample in the illuminated area. For example, as the temperature of the material sample increases, the intensity of the reflected light may decrease. Over relatively small variations in temperature (e.g., about 25° C. or less), and after an initial modulated increase in temperature, the change in intensity of the reflected light may be relatively linear. The methods disclosed herein may include examining the reflected light produced in this linear cycle of heating and cooling with the pump light after the initial increase in temperature. For example, the duration may be in the linear portion of the heating and cooling cycles of the material sample (e.g., after heating the material sample up to a steady state or average temperature of the modulated pump light).

In some embodiments, detecting reflected light from the reflective material at the photodetector may include detecting reflected light from the reflective material at a photodetector disposed on an optical arrangement, such as a lock in camera disposed behind one or more of a dichroic mirror or the like for filtering the reflected light from other light observed in the sample. For example and as shown in FIG. 7 below, the probe light source, the pump light source, an optical filter, and the photodetector (e.g., lock-in camera and/or camera) may be disposed in the optical arrangement. The reflected light corresponding to each pump light may be detected at the photodetector (e.g., lock-in camera), converted to electrical signals (e.g., voltage) or digital signals, and may be relayed to a controller or other data acquisition device. Detecting reflected light from the reflective material at the photodetector, over the duration, responsive to reflected light induced via the probe light from the probe light source may be for a duration long enough to observe or demonstrate the pattern (e.g., sinusoidal pattern) in signals received responsive to the modulated frequency of the pump light.

The method 100 includes the act 150 of (e) altering the initial modulation frequency of the pump light to an altered modulation frequency. In some embodiments, the initial modulation frequency may be any of the modulation frequencies disclosed herein. The altered modulation frequency may be different than the initial modulation frequency. Altering the initial modulation frequency of the pump light to the altered modulation frequency may include increasing the modulation frequency or decreasing the modulation frequency of pump light from the initial modulation frequency. In some embodiments, altering the initial modulation frequency of the pump light to an altered modulation frequency may include altering the modulation frequency of the pump light being emitted onto the material sample by an amount that renders the signals detected at the altered modulation frequency discernable from the initial modulation frequency. For example, altering the initial modulation frequency of the pump light to the altered modulation frequency may include increasing the frequency or decreasing the frequency of pump light from the initial frequency by a selected amount, such as 500 Hz, 600 Hz, 700 Hz, 1 kHz, 2 kHz, 3 kHz, 5 kHz, or 10 kHz. In some examples, an initial modulation frequency and a final modulation frequency may be selected. The altered modulation frequency(s) may be selected to provide a plurality (e.g., 4, 6, 8, 10, etc.) of substantially evenly spaced modulation frequencies between the initial and final modulation frequencies. The spacing may be logarithmic spacing. For example, the initial modulation frequency of 1 kHz and the final (altered) modulation frequency of 10 kHz may be selected, and the altered modulation frequencies may include 1.59 kHz, 2.51 kHz, 3.98 kHz, 6.31 kHz, and 10 KHz.

In some embodiments, altering the initial modulation frequency of the pump light to the altered modulation frequency may include modulating the intensity of the pump light beam in a sinusoidal pattern of increasing and decreasing intensities. Modulating the intensity of the pump light at the altered modulation frequency may be effective to modulate the temperature of the material sample by 25° C. or less. For example, the altered modulation frequency of the pump light may correspondingly modulate the temperature of the material sample in the illuminated region by 5° C. or less. The alteration of the temperature at the altered modulation frequency may be the same as the alteration of the temperature at the initial modulation frequency.

The method 100 includes the act 160 of (f) performing acts (b)-(e) at the altered modulation frequency. In some embodiments, performing acts (b)-(e) at the altered modulation frequency may include illuminating the surface of the material sample with pump light from the pump light source and probe light of the probe light source at the plurality of locations on the surface; modulating the intensity of the pump light at the altered modulation frequency; detecting reflected light from the reflective material at the photodetector, over a duration, responsive to reflected light induced via the probe light from the probe light source; and altering the altered modulation frequency of the pump light to an additional altered modulation frequency. The signals received at the photodetector corresponding to the altered modulation frequency may be relayed and stored in a controller or other data acquisition device.

In some embodiments, the duration over which the pump light and probe light are emitted onto the surface and over which detecting the reflected light take place at the altered modulation frequency may be the same as the duration used for the initial modulation frequency.

The method 100 includes the act 170 of (g) determining the thermal property partially based on the reflected light. In some embodiments, determining the thermal property partially based on the reflected light may include determining one or more of the thermal conductivity or diffusivity of the material sample at the initial location or one or more additional locations. The thermal conductivity and diffusivity of the material may be determined by solving the three dimensional heat (transfer) equation, such as in cylindrical coordinates, using the information in the sensed reflected light and properties of the reflective coating.

Determining the thermal property partially based on the reflected light (e.g., electrical or digital signals corresponding thereto) may include determining a phase delay ϕ in the pattern of the intensity of reflected light with respect to the corresponding modulated intensity of the pump light. For example, determining the thermal property partially based on the reflected light may include determining the phase delay ϕ in the pattern of the intensity of reflected light with respect to the corresponding modulated intensity of the pump light, which may include determining the phase of the intensity of reflected light with respect to the phase of the pump light at the modulation frequency emitted onto the material sample.

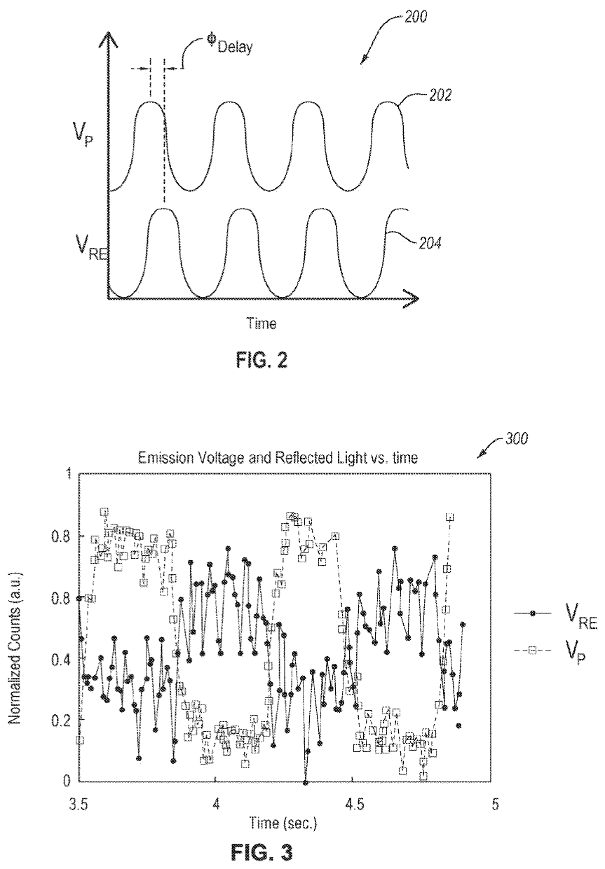

FIG. 2 is a graph 200 of the pump light intensity and reflected light intensity versus time. The voltage intensity of the pump light V_{P}—which is directly correlated to pump light intensity—emitted at the initial modulation frequency 202 is output from the pump light source prior to receiving the reflected light V_{RE} (as voltages) corresponding to the reflected light received at the photodetector. Accordingly, the reflected light V_{RE} corresponding to the modulated pump light may show a phase delayed pattern 204 corresponding to the modulation frequency of the voltage intensity of the pump light V_{P} and the distance of the reflected light from the probe light on the surface of the material. As shown in FIG. 2, the intensities (e.g., signal strength) of the reflected light V_{RE} detected from the reflected light triggered by the probe light (that is emitted at the fixed intensity) may form a pattern corresponding to the sinusoidal modulation pattern of the modulation frequency of the pump light V_{P} emitted onto the material surface. The phase delayed pattern 204 of reflected light detected from the reflected light may be compared to the initial modulation frequency 202 (e.g., sinusoidal pattern) of the modulated pump light to determine the phase delay ø therebetween. The phase delay ø can be visualized by a peak-to-peak comparison between the maximum amplitude of the sinusoidal peak heights of the initial modulation frequency 202 and the phase delayed pattern 204.

In practice, the graphs of received reflected light and modulation frequency of the pump light may be much noisier than the initial modulation frequency 202 and phase delayed pattern 204 shown in FIG. 2.

FIG. 3 is a graph 300 of the voltage intensity of pump light V_{P} and corresponding voltage intensity of the reflected light V_{RE} (detected from the reflected light triggered by the probe light) versus time. As shown, the modulation frequency of the pump light V_{P} and intensity of the reflected light V_{RE} (e.g., voltage corresponding thereto) may each follow a general sinusoidal pattern, but do so in a randomly distributed plurality of points generally tracking the initial modulation frequency 202 and the phase delayed pattern 204, respectively. In order to improve the signal-to-noise ratio of the voltage intensity of the pump light V_{P} and corresponding pattern of the voltage intensity of the reflected light V_{RE} and to only get the parts of the signal that occur at the modulation frequency of the pump light, a phase-sensitive lock-in technique may be used. The phase sensitive lock-in technique may isolate only those portions in the pattern of received reflected light that correspond to the modulation frequency of the pump light (e.g., voltage used to produce the pump light from the pump light source).

The phase sensitive lock-in technique may be carried out via software or hardware. In software applications, a phase sensitive lock-in technique may include applying a fast Fourier transform (FFT) to each of the pattern (e.g., modulation frequency) of voltage intensity of the pump light V_{P} and corresponding pattern of the voltage intensity of the reflected light V_{RE}, independently. The magnitude of the FFT pattern (e.g., modulation frequency) of voltage intensity of the pump light V_{P} and the magnitude of the FFT pattern for the voltage intensity of the reflected light V_{RE} may provide confirmation that the modulation frequency of the voltage intensity of the pump light V_{P} is tracked by the voltage intensity of the reflected light V_{RE}.

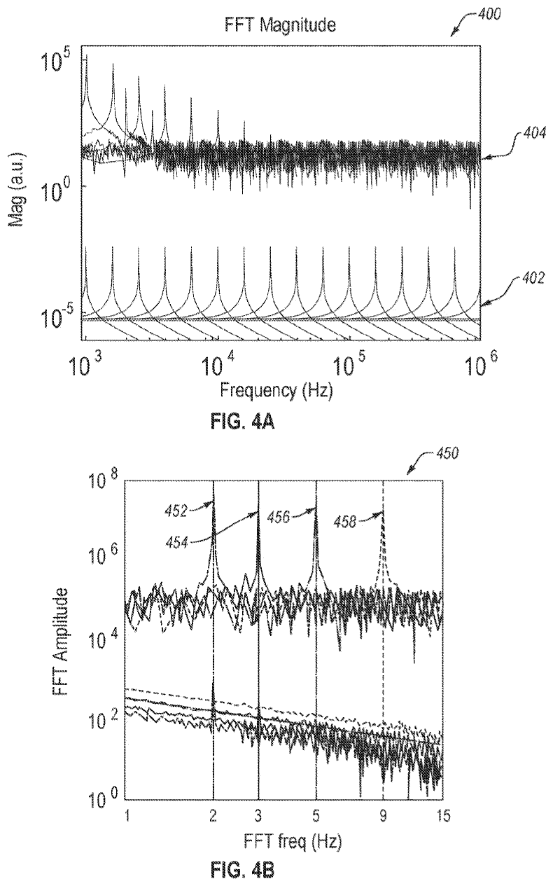

FIG. 4A is a graph 400 of the FFT magnitude (in arbitrary units, a.u.) of the voltage intensity of the pump light V_{P} and the voltage intensity of the reflected light V_{RE} versus frequency, according to an example. The graph 400 shows the FFT pattern of the voltage intensity of the reflected light V_{RE} 404 and the FFT pattern of the voltage intensity of the pump light V_{P} 402. The graph 400 shows that the magnitude of peaks in the FFT pattern of the voltage intensity of the reflected light V_{RE} 404 corresponds (or does not correspond in some cases) to the magnitude of the peaks FFT pattern of the voltage intensity of the pump light V_{P} 402 (e.g., corresponding modulation frequency). Accordingly, the software can confirm that the FFT of the voltage intensity of the pump light V_{P} is predicting the correct modulation frequency corresponding to the pattern of the voltage intensity of the reflected light V_{RE}.

FIG. 4B is a graph 450 of the FFT amplitude of the voltage intensity of the pump light V_{P} and the FFT frequency (Hz) of the voltage intensity of the reflected light V_{RE}, according to an example. As shown, the FFT amplitude of the voltage intensity of the pump light may exhibit maximums at one or more locations or points 452, 545, 456, and 458. For example, the FFT amplitude of a first selected modulation frequency of pump light may have a maximum at point 452 corresponding to the FFT frequency of 2.1 Hz, the FFT amplitude of a second selected modulation frequency of pump light may have a maximum at point 454 corresponding to the FFT frequency of 3.1 Hz, the FFT amplitude of a third selected modulation frequency of pump light may have a maximum at point 456 corresponding to the FFT frequency of 5.1 Hz, and the FFT amplitude of a fourth selected modulation frequency of pump light may have a maximum at point 454 corresponding to the FFT frequency of 9.1 Hz. The maximum amplitudes and the corresponding frequencies may be recorded and used to calculate the thermal conductivity and diffusivity. For example, the maximum amplitudes may be used to confirm the modulation frequency of the pump light. Then, using the observed modulation frequency, the amplitude of the reflected light at that frequency may be taken to be the amplitude of the thermal wave through the material sample. The phase of the reflected light at the modulation frequency may be subtracted from the phase of the pump light at the modulation frequency and that phase delay is taken to be the phase delay of the thermal wave (FIG. 2). The measured phase delay and amplitude of the thermal wave may be fit to the expected phase delay and amplitude of a thermal wave in a material with a certain thermal conductivity (k) and diffusivity (α) at a range of modulation frequencies, such as by a chi-squared analysis as described in more detail below.

Once the frequencies of each of the FFT pattern of the voltage intensity of the reflected light V_{RE} 404 and the FFT pattern of the voltage intensity of the pump light V_{P} 402 are confirmed to correspond to one another, the software programmed to perform the phase sensitive lock-in technique can determine the phase delay ϕ. The phase delay ϕ (delay of the thermal response due to heating by the pump light) can be determined by subtracting the phase of the reflected light OF from the phase of the reference signal ϕ_{IR}.

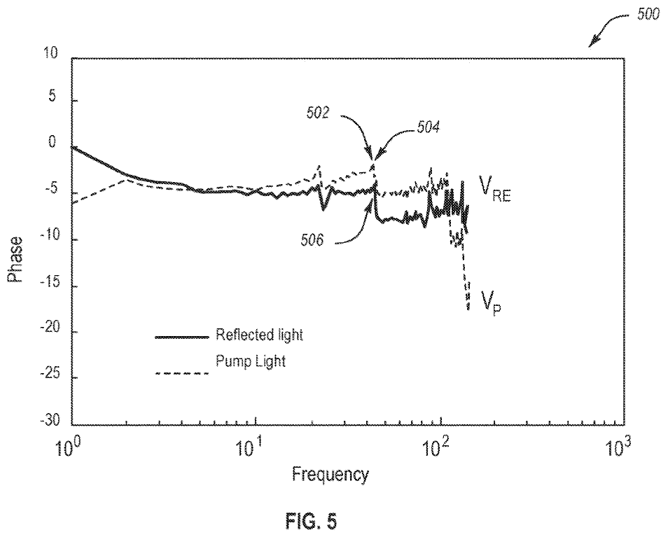

FIG. 5 is a graph 500 of the phases of the FFT pattern of the voltage intensity of the reflected light and the FFT pattern of the voltage intensity of the pump light, versus the frequencies determined by the FFT. As shown, the FFT pattern of the voltage intensity of the reflected light and the FFT of the voltage intensity of the pump light each exhibit a characteristic peak 504 and 506 at the modulation frequency (e.g., initial modulation frequency) of the pump radiation and the phase delayed pattern of the reflected light corresponding thereto. The value of the phase (ϕ_{F}) of the FFT pattern of the voltage intensity of the reflected light at peak 506 may be subtracted from value of the phase (ϕ_{IR}) of the FFT pattern of the voltage intensity of the pump light at peak 504, both taken at the characteristic peak 502 (at the modulation frequency), to determine the phase delay ϕ. The software for performing the above noted functions may be stored as machine readable and executable code in a controller, such as in a memory storage medium therein, and may be executed by a processor therein.

The hardware for determining the phase delay ϕ may include the controller or another computing device containing software for carrying out one or more portions of any of the functions or methods disclosed herein. The hardware for determining the phase delay ϕ may include a lock-in amplifier or lock-in camera. For example, the lock-in amplifier may be a commercial lock-in amplifier such as a model SR850 lock-in amplifier (from Stanford Research Systems of Sunnyvale, California). The lock-in amplifier may be set up to sense a 5 μV signal at the modulation frequency, embedded within a 100 mV signal that contains many frequencies. This may provide a signal-to-noise ratio near 90 dB. In some embodiments, the lock-in amplifier may have a signal to noise ratio of 60 dB and operate between 500 Hz and 200 kHz.

Before passing the detected voltage intensities of the reflected light V_{RE} and the voltage intensities of the pump light to a data acquisition system (e.g., computer), the detected voltage intensities of the reflected light and the voltage intensities of the pump light are fed into the lock-in amplifier. The lock-in amplifier multiplies the detected voltage intensities of the reflected light and the voltage intensities of the pump light as well as the voltage intensities of the reflected light and the voltage intensities of the pump light delayed by 90 degrees, each of which may result in two peaks. The multiplied signal may then be sent through a low pass filter to filter out the noise. The phase delay and amplitude, then at the modulation frequency, is output as an analog signal with a scaling value and offset. The phase delay and amplitude corresponding to the modulation frequency may be saved in the controller or other data acquisition system. Once the amplitude and phase delay are saved, the modulation frequency may be changed and the test may be run again at the new modulation frequency. A series of phase delays and amplitudes each corresponding to one of a plurality of modulation frequencies may be determined using the lock-in amplifier.

Similarly, a lock-in camera may determine the phase delay between visible pump light and visible probe light based on the frequencies, amplitudes, and intensity of the pump light and reflected light observed therein. The characteristics may be observed on a pixel by pixel scale and converted to voltage or digital signals for analysis and processing as disclosed above with respect to the lock-in amplifier. The lock-in camera uses an initial image of the surface and subtracts that image from all subsequent images to remove the majority of the reflected light from the surface because that light is constant and not modulated. Then it uses a trigger from a function generator to synchronize the collection of four subsequent images in a single cycle. The real (“in-phase”) portion of the reflected signal is the difference from the 1st and 3rd images (after the previous removal of the background light from above), and the imaginary (“quadrature”) portion of the reflected signal is the difference from the 2nd and 4th images (after the previous removal of the background light from above). The phase and amplitude at each pixel can then be determined from the real and imaginary images.

FIG. 6 is an illustration of a pattern 602 that may be projected from the probe light source onto the surface of the material 604 at a plurality of locations and the correspondingly measured amplitude image 610 that may be collected by the lock-in camera, according to an embodiment.

The controller (e.g., computer) may plot the phase delays and/or amplitudes as a function of the respective modulation frequencies at which the amplitudes and phase delays were determined. The plots may include one or more curves of the phase delay versus modulation frequency, such as described with respect to FIG. 5. From examining the phase delay ϕ, the thermal conductivity and diffusivity can be determined by solving the heat equation at a given set of boundary and geometry conditions at each modulation frequency and varying the thermal diffusivity (α) and thermal conductivity (k) until the error between the heat equation solution and the measured phase delay ϕ is reduced to a selected minimum range (e.g., within 5%, 10%, or 20% of the measured phase delay ϕ).

As noted above, the phase of the reflected light at the modulation frequency may be subtracted from the phase of the pump light at the modulation frequency and that phase is taken to be the phase delay of the thermal wave through the material sample. The measured phase delay and amplitude of the thermal wave are then fit to the expected phase delay and amplitude of a thermal wave in the material with a certain thermal conductivity (k) and thermal diffusivity (α) at a range of modulation frequencies. The phase delay ϕ is the plotted phase, when the plotted phase is the difference of the phase of the pump light (e.g., reference pump light) and the phase of the reflected light, minus any additional phase delay contribution from the electronics (e.g., photodetector, wiring, etc.).

In non-homogenous samples, where the thermal conductivity or thermal diffusivity is different at different locations due to material variations, the amplitude and phase delay of the thermal wave corresponding to the different locations would vary and provide different curves.

In some embodiments, the controller (e.g., data acquisition software and/or hardware) may record both the intensity of pump light (voltage used to emit the pump light) and corresponding intensity of the reflected light (voltage corresponding to the reflected light detected) for use in determining the phase delay between the modulation in each pattern corresponding thereto. Such recordation may be carried for a plurality of locations on the material sample, such as sequentially or contemporaneously.

Returning to FIG. 1, the act 170 of determining the thermal property partially based on the reflected light may include determining an amplitude of the pattern of reflected light received by the photodetector, wherein the pattern of reflected light corresponds to a phase delay compared to the modulated intensity of the pump light corresponding thereto. In some embodiments, determining an amplitude of the pattern of reflected light received by the photodetector may include performing a fast Fourier transformation on the plurality (e.g., pattern) of reflected light signals. The fast Fourier transform may demonstrate the maximum amplitude and at which frequencies of the fast Fourier transformed signals the maximum amplitude takes place.

The FFT amplitude may be used as a confirmation for the determined thermal conductivity and diffusivity. By fitting to both the phase delay and the normalized amplitude (e.g., all values are divided by the amplitude of the thermal wave at the lowest modulation frequency) the uncertainty of the property value (e.g., thermal conductivity and diffusivity) can be reduced. The phase delay represents absolute values, which may allow absolute determination of the thermal conductivity and diffusivity (because each value of thermal conductivity and diffusivity has a specific phase delay at each modulation frequency). However, the amplitude values are relative to each other, and thus can only be used in fitting to get thermal diffusivity in conjunction with the phase values.

The act 170 of determining the thermal property partially based on the reflected light may include plotting the amplitude and phase delay of each pattern of reflected light as a function of modulation frequency of the pump light (e.g., pump laser). The act 170 may include using the plotted amplitudes and phase delays of the patterns of reflected light, as a function of the modulation frequency of the pump light corresponding to the plotted amplitudes and phases, to solve for thermal diffusivity of a portion (e.g., irradiated portion) of the material sample using the heat equation. The plots may be used to make curves to be used to calculate thermal conductivity and diffusivity as described below.

The act 170 of determining the thermal property partially based on the reflected light may include determining the thermal conductivity and diffusivity of the material sample at plurality of locations thereon by solving the heat equation at each of the plurality of locations. In some embodiments, solving the three dimensional heat equation may include solving the heat equation in Cartesian or cylindrical coordinates. Solving the heat equation at each of the plurality of locations may include solving the heat equation using the phase delay ϕ and normalized amplitude determined from the lock-in procedure, such as any of those disclosed above.

The three dimensional heat equation (in cylindrical coordinates) may be as follows:

$$\frac{{\partial }^{2} T}{\partial {r}^{2}} + \frac{1}{r} \frac{\partial T}{\partial r} + \frac{1}{{r}^{2}} \frac{{\partial }^{2} T}{\partial {φ}^{2}} + \frac{{\partial }^{2} T}{\partial {z}^{2}} - \frac{1}{α} \frac{\partial T}{\partial t} = 0 \qquad Equation 1$$

where T=Ambient temperature+temperature added from alternating laser intensity+temperature added by the average intensity of the laser, t=time, r=radius, z=distance between light source(s) on the surface of material; and ϕ=the polar angle is determined as described above.

The value T(r, z, φ, t) may be converted to Ť(r, z, φ)e^{iωt}, where ω=2πf and f=the modulation frequency. Accordingly, determining the thermal conductivity (k) and diffusivity (α) of the material sample at plurality of locations thereon by solving the heat equation at each of the plurality of locations may include changing (e.g., converting) the heat equation to the corresponding equation below.

$$\frac{{\partial }^{2} {T}^{⌣}}{\partial {r}^{2}} + \frac{1}{r} \frac{\partial {T}^{⌣}}{\partial r} + \frac{1}{{r}^{2}} \frac{{\partial }^{2} {T}^{⌣}}{\partial {φ}^{2}} + \frac{{\partial }^{2} {T}^{⌣}}{\partial {z}^{2}} - {q}^{2} \partial {T}^{⌣} = 0 \qquad Equation 2$$

where

$$q = \sqrt{\frac{i ω}{α}} ,$$

and α=thermal diffusivity.

By applying a spatial Fourier transformation to Equation 2, the dimensions of the heat equation of Equation 2 can be reduced to 2. The resulting Equation 3 may be as shown below.

$$\frac{{\partial }^{2} t}{\partial {r}^{2}} + \frac{1}{r} \frac{\partial t}{\partial r} + \frac{1}{{r}^{2}} \frac{{\partial }^{2} t}{\partial {φ}^{2}} - {δ}^{2} t = 0 \qquad Equation 3$$

$$where δ = ( i ω / α ) + {λ}^{2} .$$

Equation 3 can be solved with separation of variables and with the boundary conditions relating to conduction in the surrounding atmosphere and in the sample as set forth below. The temperature in the material is assumed as the temperature at the surface of the material. At the surface r=q. Equation 3 converts to Equation 4 below.

$${T}_{s} ( r , z , φ ) = {\int }_{- ∞}^{∞} {e}^{i λ z} \frac{{P}_{o} {e}^{- {λ}^{2} \frac{{b}^{2}}{8}}}{4 π {k}_{s} {δ}_{s}} [ \frac{{\hat{Z}}_{n = - θ}^{∞} ( \frac{{( - i )}^{n} cos ( n \frac{π}{2} )}{π ( 1 - {n}^{2} )} )}{Bessel Function ( s )} ] d λ \qquad Equation 4$$

where P=absorbed laser (e.g., pump light) power, b=1/e² width of the pump light beam, k=thermal conductivity, and the subscript “s” refers to the surface of the sample.

By simplifying and numerically solving Equation 4 assuming no variations in the polar angle (φ) properties, the thermal conductivity (k) and diffusivity (α) can be determined. Assuming no heat losses and an infinitely small spot size for the pump light, Equation 4 can be converted to the Equation 5 below for the surface of the cylinder.

$${\check{T}}_{s} ( a , z ) = \frac{{P}_{o}}{2 π {k}_{o} a} [ cos ( Γ \sqrt{\frac{i ω}{α}} z ) + i sin ( \sqrt{\frac{i ω}{α}} z ) ] \qquad Equation 5$$

Equation 5 can be used to solve for the thermal conductivity (k) and diffusivity (α) using both the real and imaginary components of the temperature. The equation for solving for α using the real and imaginary components of the phase delay may be as shown below in Equation 6.

$$Φ = {tan}^{- 1} [ \frac{\frac{{P}_{o}}{2 π {k}_{o} a} imaginary [ cos ( \sqrt{\frac{i ω}{α}} z ) + i sin ( \sqrt{\frac{i ω}{α}} z ) ]}{\frac{{P}_{o}}{2 π {k}_{o} a} real [ cos ( \sqrt{\frac{i ω}{α}} z ) + i sin ( \sqrt{\frac{i ω}{α}} z ) ]} ] \qquad Equation 6$$

Because z (e.g., the distance between the light source(s)) remains constant, varying ω or the value for f (modulation frequency) therein provides ϕ(ω, α), where ω=2πf.

Using the thermal model of Equation 6 with a guess for thermal conductivity k and thermal diffusivity α, the error of the model at the guessed k and α can be calculated. The error is calculated by a chi-squared goodness-of-fit criterion, where the sum of the squared difference between the experimental data (e.g., observed reflected light and the determined thermal diffusivity corresponding thereto) and curve fit are minimized. Tracking the error at different guessed thermal diffusivity values allows the curve fitting process to converge on physical reasonable property values for thermal diffusivity of the material(s) in the sample (e.g., between 10⁻³ m²/s-10⁻⁸ m²/s). Using a Levenberg-Marquardt non-linear curve-fitting program, the guessed thermal diffusivity α (and other parameters) is varied until the chi-squared value is minimized after multiple iterations. The value of the guessed k and α with the lowest error to the curve fit is taken as the thermal conductivity k and thermal diffusivity α of the sample near the irradiated location (irradiated by the pump light).

The chi-squared analysis is used to give a base estimate of the uncertainty of the lowest error, curve-fit, thermal conductivity k and thermal diffusivity α value. The chi-squared analysis may demonstrate that the lowest error, curve-fit, thermal conductivity k and thermal diffusivity value a and the corresponding values for the phase delay ϕ fit the curve within an acceptable level of error (e.g., 10% in either direction). Accordingly, the uncertainty of the thermal conductivity k and thermal diffusivity α can be determined at specific values of the phase delay ϕ on the Levenberg-Marquardt non-linear curve. The thermal conductivity k and thermal diffusivity α at the minimized error value is taken as the thermal conductivity and diffusivity of the material sample at the irradiated location of the sample.

The equations above are merely examples and may be different in one or more aspects depending on one or more of the boundary conditions of the sample and the surrounding environment. The form of the heat equation used (e.g., Cartesian or cylindrical) may differ from the examples provided above accordingly.

The thermal conductivity of the sample can be determined when the thermal properties and thickness of the reflective coating are known and the heat equation of each material is coupled and solved in a similar way. The thermal properties and thickness of the reflective coating can be determined by depositing the reflective coating onto a reference sample material, such as boro-silicate or BK7 glass, where the thermal properties and thickness of sample are known. The thickness of the reflective coating can be determined during the deposition process, via ellipsometry, and by measuring the percent of light transmitted through the coating a certain wavelength of light. FIG. 7 is a graph of the coefficient of thermoreflectance for several metals that may be disposed as the reflective material on a surface of the material sample.

In some embodiments, determining the thermal property partially based on the reflected light may include determining the amplitude and phase of each pattern of reflected light as a function of a corresponding modulation frequency of the pump light emitted from the pump light source (e.g., pump laser) and the distance between the reflected probe light and the pump light on the surface of the sample. In some embodiments, determining the thermal property partially based on the reflected light may include using the amplitudes and phases of the patterns of reflected light (as a function of the corresponding modulation frequencies of the pump light source) to make plots (having curves) to solve for thermal conductivity and diffusivity of the material sample at each of the one or more locations on the material sample, using the heat equation. Determining the amplitude and phase of each pattern may be as described above. Using the amplitudes and phase delays of the patterns of reflected light to solve for thermal conductivity and diffusivity of the material sample at each of the plurality of locations may be as described above.

The method 100 includes the act (h) of translating the probe light patterns to a different location or locations relative to the corresponding pump light(s) and performing one or more of acts (b)-(g) at the different location(s). The translation may be accomplished by moving the probe light itself, by emitting probe lights at different selected distances from the pump light, or by repositioning the sample with respect to the pump and probe light positions to test different portions of the material. By varying the location of the probe light(s) relative to the pump light, the characteristics of the material can be examined more completely. The method 100 may include determining physical properties of the material based at least on the thermal properties/characteristics. For example, grain boundaries, degradation, different materials, or other material discontinuities may be identified in the material sample based on differences in thermal characteristics as measured by the phase delay of the reflected light as a function of distance from the pump light location.

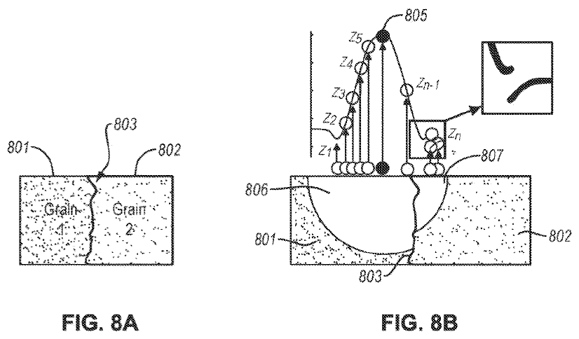

FIG. 8A is an illustration of a thermal contact interface at a grain boundary between two grains, according to an embodiment. The first grain 801 and second grain 802 share a thermal contact interface 803 therebetween. FIG. 8B is an illustration of the thermal contact interface of the two grains of FIG. 8A with a thermal wave spreading therethrough and the corresponding phase delay graph, according to an embodiment. As shown, the pump light location 805 and probe light locations Z₁-Z₅ and Zₙ₋₁ are on the first grain 801 and the probe light location Zₙ is on the second grain 802. The grain boundary 803 is located between probe light locations Zₙ₋₁ and Zₙ on the neighboring grains and it is expected that a discontinuity in the phase delay curve will be observed at the grain boundary 803. Put another way, a discontinuity in a phase delay curve for a pump light location is indicative of a discontinuity in the material. As shown, the thermal wave 806 is delayed at the grain boundary 803 and spreads into the second grain 802 as the phased delayed thermal wave 807.

By translating the positions of the probe (e.g., green) light across the grain and/or the boundary, the lock-in camera collects the phase delay as a function of distance from the pump light (e.g., red laser) sites. This results in a direct measurement of properties of many grain boundaries in a rapid, parallelized manner. Rₖ of grain boundaries can then be determined by fitting the appropriate thermal model. This is accomplished by determining the thermal diffusivity (α) of the grain where the scan starts, where α is calculated as the slope of the phase delay curve (unbroken curve in FIG. 8B). As the thermal wave passes through the grain boundary, an extra phase shift is added and the temperature field is changed to Equation 7 below, assuming the heat source is at some distance z=z′, and that the interface is vertical at position z=0.

$${Δ T ( z ) = {R}_{k} ( \frac{{P}_{0}}{4 π} ) {\int }_{0}^{∞} {e}^{( - σ \vert z \vert \frac{{p}^{2} {R}^{2}}{8} )} 2 + {R}_{k} k σ )}^{- 1} \times [ {e}^{- σ {z}^{′}} erfc ( B ) - exp ( σ {z}^{′} ) erfc ( B ) ] dp , with B = \frac{σ R}{2 \sqrt{2}} - \frac{\sqrt{( 2 )} {z}^{′}}{R} \qquad Equation 7$$

where P₀ is the amplitude of the input heat flux, R is reflectivity, p is the Hankel transform variable, and σ is the modified thermal wave vector (σ=\sqrt{ωi/α+p²}).

By subtracting the background phase due to the grain from the signal, the remaining phase delay changes are due to the Kapitza resistance, Rₖ, which can be fit to Equation 7. Experimentally, this subtracted curve is flat, has a slight increase at the boundary, and then drops to the resulting phase when the wave is within the neighboring grain (FIG. 8B). Further development of this model to account for an angled boundary, non-constant grain properties, or anisotropic properties may be utilized to refine the determination of the presence/location of grain boundaries. The technique and equations above for determining Kapitza resistance of a grain boundary are merely examples and may be different in one or more aspects depending on one or more of the boundary conditions of the sample and the surrounding environment.

The act 170 of determining the thermal property partially based on the reflected light may include calculating the slope of the phase delay curve to determine the thermal diffusivity of the grain and subtracting the background phase of the thermal diffusivity of the grain. The act 170 of determining the thermal property partially based on the reflected light may include utilizing equation 7 and solving for Rₖ.

Referring to FIG. 8B, by varying the frequency of the pump light 805, the thermal wave can penetrate varying distances through the grain boundary. This results in a change in phase of the wave, which can provide a measurement of Rₖ. This phase is measured at multiple locations by imaging the position of the probe light from one side of the pump light 805 through the grain boundary 803, such as from Z₁-Zₙ.

In some embodiments, determining the thermal conductivity and diffusivity of one or more portions of the material sample at least partially based on the reflected light may include determining the amplitude and phase delay of each pattern of reflected light as a function of a corresponding modulation frequency of the pump light, and using the amplitude and phase of the pattern of reflected light, as a function of the corresponding modulation frequencies of the pump light, to solve for thermal conductivity and diffusivity of the material sample at each of the plurality of locations using the heat equation.

Differing thermal conductivity and diffusivity values may indicate different materials at the respective locations. In applications where the material is supposed to be consistent throughout, the comparison may be able to detect inconsistencies in the material, such as due to poor manufacturing or degradation during use. For example, a difference in thermal conductivity and diffusivities may indicating that a Zircaloy® cladding of a nuclear fuel has been degraded by detecting differences in thermal conductivity and diffusivity indicative of the presence of a degradation product thereof, such as zirconium hydride. In such examples, a lower thermal conductivity and diffusivity than several other determined thermal diffusivities may indicate that a region may have zirconia hydride therein.

In some embodiments, the method 100 may include plotting the determined thermal diffusivities of the sample as a function of position of the irradiated areas of the material sample corresponding to the thermal diffusivities, such as to indicate a location of the differing materials or degradation in the materials of the sample.

In some embodiments, the method 100 may include correlating the thermal conductivity and diffusivity of the material at the plurality of locations with a reference thermal conductivity and diffusivity of one or more known materials to determine a species of the material at the initial location and the at least one additional location. Such correlation can be carried out with a controller, such as by utilizing one or more look-up tables stored in a memory thereof.

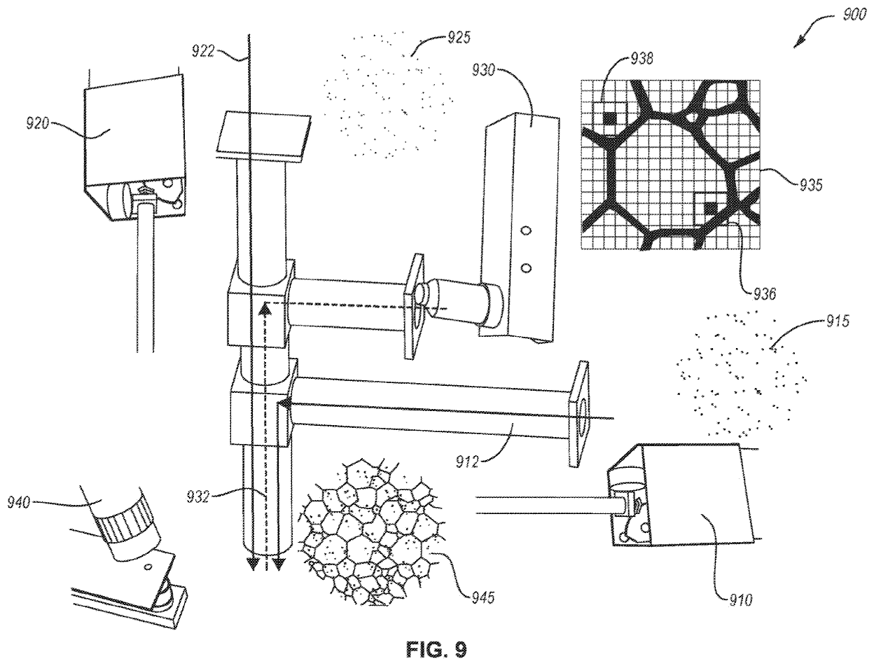

The method 100 may be carried out on a system having an optical arrangement and a computing device. FIG. 9 is an illustration of an optical arrangement 900, according to an embodiment. The optical arrangement 900 (e.g., system) in FIG. 9 may be utilized for PSDTR. The system in FIG. 9 utilizes a pump light projector 910 projecting pump light 912 (e.g., red laser light), a probe light projector 920 such as for projecting probe light 922 (e.g., green laser light), and a lock-in camera 930 for detecting reflected probe light 932. Suitable pump light projectors may include a laser, an LED light projector, or a DLP projector such as a Wintech PRO6500HR DLP projector (available from Wintech Digital System Technology Corp. of San Marcos, California, U.S.A.). Suitable probe light projectors may include a laser, an LED light projector, or a DLP projector (Wintech PRO6500HR DLP projector). The light projectors 910 or 920 may include a beam splitter, mirrors, or the like. One micro-mirror array (e.g., digital micromirror device or “DMD”) in the DLP projector of the pump light source projects a modulated pump light 912 (e.g., red laser spots) to heat the surface of the material sample at hundreds of points, while a separate DMD in the probe light projector 920 independently projects probe light 922 (e.g., green spots) nearby each pump light spot (e.g., red spot). An example pump light image 915 shows a plurality of pump light spots on a sample. An example probe light image 925 shows a plurality of probe light spots on the sample.

The heat from the pump light 912 (e.g., red laser) causes periodic variations in the temperature of the nearby area (called a thermal wave, FIG. 8B), which then results in periodic variations of the reflectance of the reflective material (e.g., gold film) disposed on the material sample. This results in an AC component (sinusoidal variation) to the reflected probe light 932 (e.g., green light), and the phase delay between the original pump light (red) modulation waveform and the reflected probe (green) light is related to the thermal properties of the illuminated area. This phase delay is detected with the lock-in camera 930, and is used to determine the thermal properties of the area(s) under the pump light 912. As shown in the pixel image 935, the lock-in camera 930 may collect pixels 936 that contain probe light 938 or overlapping probe light (e.g., red) pixels. Likewise, the reflected probe (green) light may be collected by the lock-in camera 930 for pixels with modulation that matches the modulation of the pump light 912 (though separated by a phase delay).

The optical arrangement 900 may include a microscope 940 for capturing an image of the sample. For example, the microscope 940 may be used to capture a sample image 945 of one or both of the pump light and probe light on the material sample surface. As shown, the grain boundaries may be visible in the sample image 945 taken by the microscope. Such images may be used to confirm the location of grain boundaries, material discontinuities, or the like.

While not shown, the optical arrangement 900 may include or be coupled to a controller (e.g., computing system) for controlling one or more components of the optical arrangement 900, such as the pump light projector 910, the probe light projector 920, the lock-in camera 930, the microscope 940, or one or more components therebetween (e.g., mirrors). The controller may be configured to process the data received by the lock-in camera 930, such as is described above with respect to the method 100. For example, the controller may include a memory storage device having machine readable and executable instructions for performing any of the acts of the method 100 and the controller may include a processor configured to read and execute the instructions. One or more functions of the controller may be carried out automatically, such as responsive to receiving a command or data from a component of the system (e.g., data from the lock-in camera or camera).

One or more components of the system 900 may be operably coupled together via one or more conduits, mirrors, circuitry, wiring, or mechanical components.

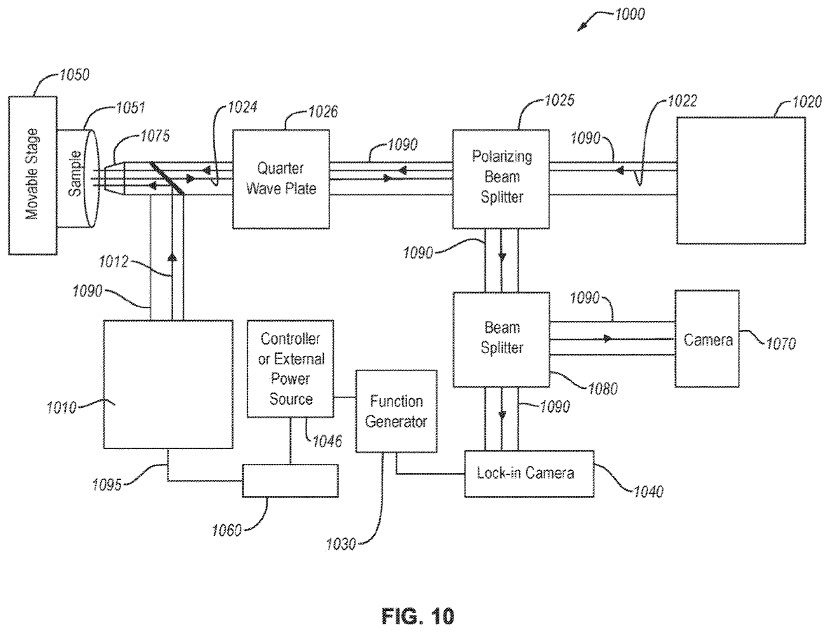

FIG. 10 is a block diagram of a layout of components for an optical arrangement 1000 (or system) and path of laser light used for PSDTR, according to an embodiment. As shown, the optical arrangement 1000 includes a pump light projector 1010 (e.g., laser projector), a pump light source 1060 (e.g., laser) (or collectively a pump light source), a probe light source or projector 1020 (e.g., LED projector, DLP projector, or laser), a function generator 1030, a lock-in camera 1040 and controller 1046 with an optional external power source. The pump light 1012 (red laser) is directed onto the material sample 1051 on a movable stage 1050 via a dichroic mirror 1015 disposed between the material sample 1051 and the pump light source 1010. The function generator 130 is configured to create the sine wave modulation of the intensity of the pump light, and to send a signal to the LIC to make sure the pump light source and the lock-in camera 1040 images are synched to the same frequency. The optical arrangement 1000 includes the probe light source 1020 such as an LED projector or DLP projector, a polarizing beam splitter 1025, and a quarter wave plate 1026. The (green) probe light 1022 may be directed onto the sample 1051 and reflected probe light 1024 is allowed through the dichroic mirror 1015, back through the quarter wave plate 1026, and into the polarizing beam splitter 1025. The polarizing beam splitter 1025 directs the reflected probe light 1024 to a lock-in camera 1040. A beam splitter 1080 may split the reflected beam to arrive at another camera 1070, separate from the lock-in camera 1040. The components of the optical arrangement 1000 may be connected to each other via one or more tubes. The one or more tubes may be adjustable length tubes between one or more of the components. One or more components of the optical arrangement may be connected to each other by an electrical or electromagnetic propagating connection 1095, such as fiber optic cables, electrical cables, or the like. For example, the controller 1046 may be operably coupled to one or more of the pump light source 1060, the pump light projector 1010, the function generator 1030, the lock-in camera 1040, the probe light source 1020, or the like via one or more electrical cables.

The sample position may be adjusted using the movable stage 1050. The movable stage may include one or more encoders, servo motors, stepper motors, directed drive motors, or the like for controlling a position of the movable stage with respect to one or more components of the optical arrangement 1000. For example, one or more components of the optical arrangement 1000 may be moved with respect to the material sample, such as in the x, y, z directions or any combinations thereof.

An image of the material sample 1051 may be captured using the camera 1070 via the microscope objective 1075. The microscope objective 1075 may include a lens sized, shaped, and positioned to capture an image of the material sample 1051 including any pump light or probe light thereon.

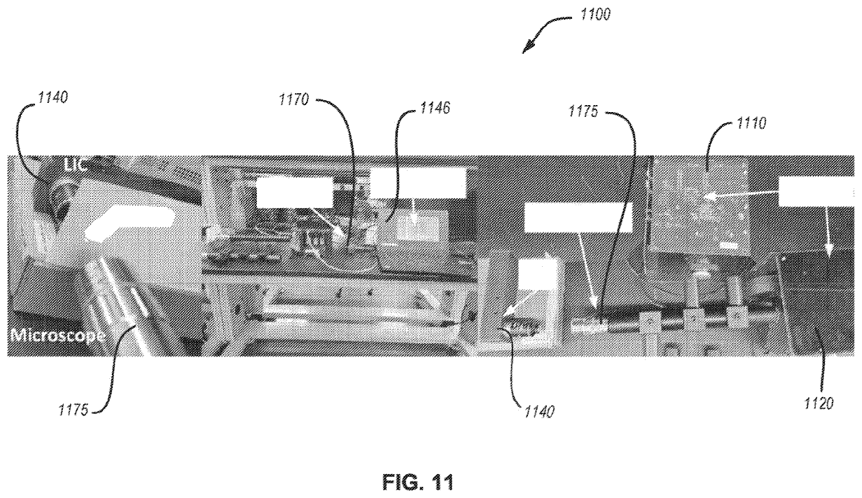

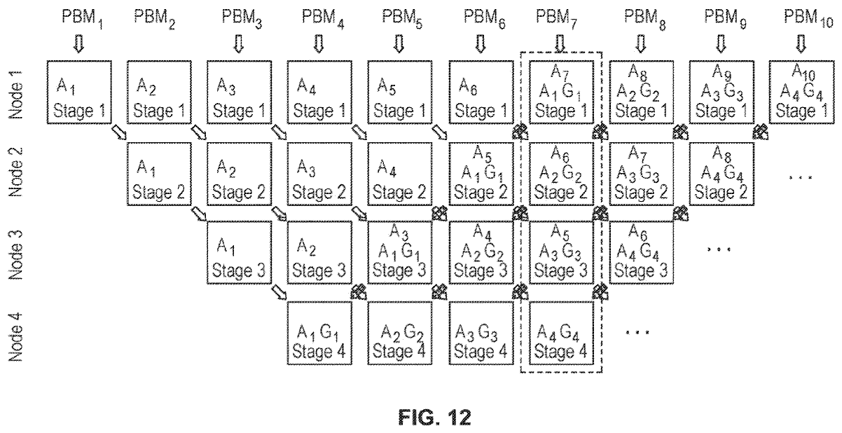

FIG. 11 are photographs of a system 1100 containing components of the optical arrangements disclosed herein, according to an embodiment. The system 1100 includes a hardware set-up for testing components of the optical arrangements disclosed herein. The system 1100 includes a pump light source 1110, a probe light source 1120, a microscope 1175, a lock-in camera 1140, a controller 1146, and a camera 1170.

As noted above, by varying the frequency of the pump light (red), a thermal wave can penetrate through the grain boundary. This results in a change in phase of the wave, which can provide a measurement of Rₖ. This phase is measured at multiple locations by varying the position of the probe light (green) from one side of the pump light through the grain boundary (z1 to zn).

The systems disclosed herein may utilize software to analyze data corresponding to the pump light and probe light. In embodiments, to measure Rₖ of a set of 100 grain boundaries, two 135 kB images (amplitude and phase) may be used for one set of pump/probe positions. A set of pump/probe positions may mean 100 different grain boundary locations that have been identified for characterization. A pump spot may be projected within about 5 μm of each grain boundary, and a probe beam may be projected about 20 μm to the left of each pump spot (z₁ in FIG. 8B). To perform the spatial scan (varying the distance between the pump and probe spots through a grain boundary), 41 different probe positions may be measured for a pump light spot, meaning successive images with a fixed pump light spot location but varying probe light spots are sent to the projector (z₂-zₙ in FIG. 8B). Uncertainty due to the inverse problem (fitting the model to the phase delay to determine Rₖ) can be reduced by performing the spatial scan at multiple laser modulation frequencies (commonly 5, 10, 20, 50 kHz). This will result in approximately 44 MB of images per set of pump/probe positions. Repeating this process 1,000 times to get measurements of 10⁵ grain boundaries would result in gigabytes of images. Analysis and tracking of this large amount of data may be accomplished through a well detailed workflow focused on relating known projected image locations to microscope images taken to identify candidate grain boundaries. The amplitude (A) and phase (ϕ) images from the lock-in camera can then be reduced to numerical data based on the intensity of each image only at the projected locations.

The data may then be sent to a supercomputer to perform the thermal model fitting to determine Rₖ at the grain boundaries of interest. The parallelization of the supercomputer is very useful because the 500,000 sets of probe light position vs measured phase that would result when measuring 10⁵ grain boundaries could require over 1 million minutes on a single computer to perform all the necessary fittings, but can be reduced to about 2 days of computing time using 400 nodes. Each probe light measurement will be modeled independently on a separate batch. The algorithm begins by sending a test batch. This data sample is processed in a single pass and returns the preliminary results to the admin, asking for confirmation to proceed with the effective batch size. For every batch, the model is further partitioned into multiple mini-batches where the output of a stage is the input of the next stage. Each stage is assigned to a node which computes a layer.

Each node determines the thermal properties of a single heating spot. Each node does this by taking information from the phase image from the LIC at each of the probe light spots related to the corresponding pump light spot. This creates a phase vs position that is fit to the solution of the heat transfer equation to determine thermal conductivity and thermal diffusivity of the sample. This is repeated for each of the modulation frequencies and the average thermal property from all those calculations is selected as the measured thermal properties.

Any portions of the method 100 may be carried out on a supercomputer or plurality of computers operably coupled to or receiving information from a controller or photodetector (e.g., lock-in camera) of the optical arrangement. In such examples, the one or more portions of the determination of the thermal property of the material sample at a plurality of probe light and corresponding pump light locations may be performed in parallel (e.g., contemporaneously) by the supercomputer.

FIG. 12 is a block diagram of a sample data processing pipeline with four stages according, to an embodiment. An represents a forward computation, AₙGₙ represents backpropagation. The dashed box highlights maximum CPU utilization time. When the first node receives a mini-batch of data probe light (beam) measurement 1 (PBM1) and the first stage is executed, the second node starts to execute the second stage and, at the same time, the first node receives the next mini-batch of data PBM2 and starts to execute the first stage, and so on. Each node performs not only forward computation of the corresponding layer, but also backpropagation to compute the gradient. By dividing work by stages in this way, each node is readied for re-computation, saving activation inputs and providing in-processor memory savings.

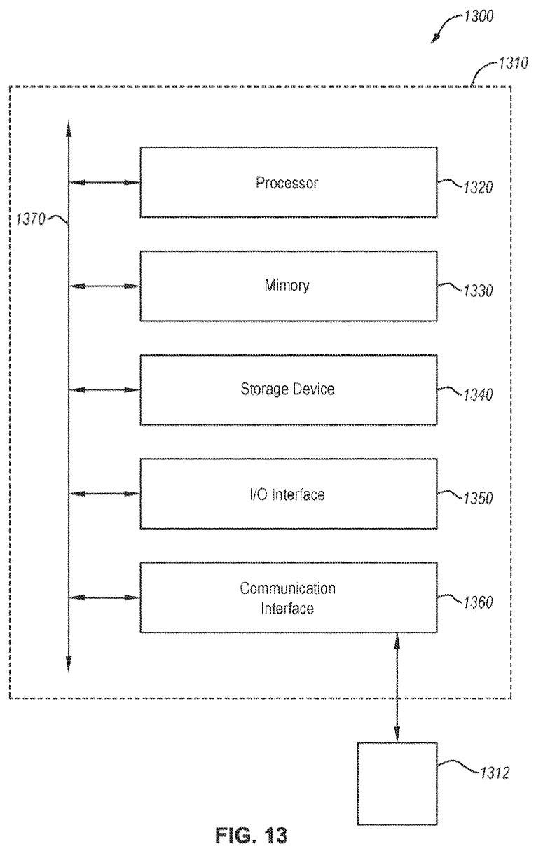

Any of the example systems disclosed herein may be used to carry out any of the example methods disclosed herein, such as using the controller. FIG. 13 is a schematic of a controller 1300 for executing any of the example methods disclosed herein, according to an embodiment. The controller 1300 may be configured to implement any of the example methods disclosed herein, such as the method 100. The controller 1300 includes at least one computing device 1310. The at least one computing device 1310 is an exemplary computing device that may be configured to perform one or more of the acts described above, such as the method 100. The at least one computing device 1310 can include one or more servers, one or more computers (e.g., desk-top computer, lap-top computer), one or more mobile computing devices (e.g., smartphone, tablet, etc.), or one or more custom computing devices. The computing device 1310 can comprise at least one processor 1320, memory 1330, a storage device 1340, an input/output (“I/O”) device/interface 1350, and a communication interface 1360. While an example computing device 1310 is shown in FIG. 13, the components illustrated in FIG. 13 are not intended to be limiting of the controller 1300 or computing device 1310. Additional or alternative components may be used in some embodiments. Further, in some embodiments, the controller 1300 or the computing device 1310 can include fewer components than those shown in FIG. 13. For example, the controller 1300 may not include the one or more additional computing devices 1312. In some embodiments, the at least one computing device 1310 may include a plurality of computing devices, such as a server farm, computational network, or cluster of computing devices. Components of computing device 1310 shown in FIG. 13 are described in additional detail below. In some embodiments, one or more components of the controller 1300 or the computing device 1310 may be located remotely from one or more other components of the controller 1300 or the computing device 1310. In some embodiments, one or more components of the controller 1300 or the computing device 1310 may be located within, in electronic communication with, or on the optical arrangement (FIGS. 9 and 10).

In some embodiments, the processor(s) 1320 includes hardware for executing instructions (e.g., instructions for carrying out one or more portions of any of the methods disclosed herein), such as those making up a computer program. For example, to execute instructions, the processor(s) 1320 may retrieve (or fetch) the instructions from an internal register, an internal cache, the memory 1330, or a storage device 1340 and decode and execute them. In particular examples, processor(s) 1320 may include one or more internal caches for data such as look-up tables or data libraries. As an example, the processor(s) 1320 may include one or more instruction caches, one or more data caches, and one or more translation lookaside buffers (TLBs). Instructions in the instruction caches may be copies of instructions in memory 1330 or storage device 1340. In some embodiments, the processor 1320 may be configured (e.g., include programming stored thereon or executed thereby) to carry out one or more portions of any of the example methods disclosed herein.

In some embodiments, the processor 1320 is configured to perform any of the acts disclosed herein such as in method 100 or cause one or more portions of the computing device 1310 or controller 1300 to perform at least one of the acts disclosed herein. Such configuration can include one or more operational programs (e.g., computer program products) that are executable by the at least one processor 1320. For example, the processor 1320 may be configured to automatically determine the phase delay of a pattern of reflected light emitted from the reflective material on the material sample (responsive to probe light) with respect to the pump light that irradiates the material sample while the probe light is emitted onto the material sample, as disclosed herein, according to an operational program for executing the same.

The at least one computing device 1310 (e.g., a server) may include at least one memory storage medium (e.g., memory 1330 and/or storage device 1340). The computing device 1310 may include memory 1330, which is operably coupled to the processor(s) 1320. The memory 1330 may be used for storing data, metadata, and programs for execution by the processor(s) 1320. The memory 1330 may include one or more of volatile and non-volatile memories, such as Random Access Memory (RAM), Read Only Memory (ROM), a solid state disk (SSD), Flash, Phase Change Memory (PCM), or other types of data storage. The memory 1330 may be internal or distributed memory.

The computing device 1310 may include the storage device 1340 having storage for storing data or instructions. The storage device 1340 may be operably coupled to the at least one processor 1320. In some embodiments, the storage device 1340 can comprise a non-transitory memory storage medium, such as any of those described above. The storage device 1340 (e.g., non-transitory storage medium) may include a hard disk drive (HDD), a floppy disk drive, flash memory, an optical disc, a magneto-optical disc, magnetic tape, or a Universal Serial Bus (USB) drive or a combination of two or more of these. Storage device 1340 may include removable or non-removable (or fixed) media. Storage device 1340 may be internal or external to the computing device 1310. In some embodiments, storage device 1340 may include non-volatile, solid-state memory. In some embodiments, storage device 1340 may include read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these. In some embodiments, one or more portions of the memory 1330 and/or storage device 1340 (e.g., memory storage medium(s)) may store one or more databases thereon. At least some of the databases may be used to store one or more of modulation frequencies, signals (voltages) received from the photodetector corresponding to the reflected light received by the photodetector, determined thermal diffusivities, or know thermal diffusivities corresponding to known materials, as disclosed herein.

In some embodiments, one or more of modulation frequencies, signals (voltages) received from the photodetector corresponding to the reflected light received by the photodetector, determined thermal diffusivities (and thermal conductivities and R_{k′}s), or known thermal diffusivities (and thermal conductivities and R_{k′}s) corresponding to known materials, may be stored in a memory storage medium such as one or more of the at least one processor 1320 (e.g., internal cache of the processor), memory 1330, or the storage device 1340. In some embodiments, the at least one processor 1320 may be configured to access (e.g., via bus 1370) the memory storage medium(s) such as one or more of the memory 1330 or the storage device 1340. For example, the at least one processor 1320 may receive and store the data (e.g., look-up tables) as a plurality of data points in the memory storage medium(s). The at least one processor 1320 may execute programming stored therein adapted access the data in the memory storage medium(s) to automatically control the systems disclosed herein such as to determine the thermal conductivity and diffusivity of a sample at one or more locations thereon. For example, the at least one processor 1320 may access one or more look-up tables or operational programs in the memory storage medium(s) such as memory 1330 or storage device 1340. The one or more operational programs may include machine readable and executable instructions for directing the controller to perform or cause any components of any of the systems disclosed herein to perform any portions of the methods disclosed herein.

The computing device 1310 also includes one or more I/O devices/interfaces 1350, which are provided to allow a user to provide input to, receive output from, and otherwise transfer data to and from the computing device 1310. These I/O devices/interfaces 1350 may include a mouse, keypad or a keyboard, a touch screen, camera, optical scanner, network interface, web-based access, modem, a port, other known I/O devices or a combination of such I/O devices/interfaces 1350. The touch screen may be activated with a stylus or a finger.

The I/O devices/interfaces 1350 may include one or more devices for presenting output to a user, including, but not limited to, a graphics engine, a display (e.g., a display screen or monitor), one or more output drivers (e.g., display drivers), one or more audio speakers, and one or more audio drivers. In certain examples, I/O devices/interfaces 1350 are configured to provide graphical data to a display for presentation to a user. The graphical data may be representative of one or more graphical user interfaces and/or any other graphical content as may serve a particular implementation.

The computing device 1310 can further include a communication interface 1360. The communication interface 1360 can include hardware, software, or both. The communication interface 1360 can provide one or more interfaces for communication (such as, for example, packet-based communication) between the computing device 1310 and one or more additional computing devices 1312 or one or more networks. For example, communication interface 1360 may include a network interface controller (NIC) or network adapter for communicating with an Ethernet or other wire-based network or a wireless NIC (WNIC) or wireless adapter for communicating with a wireless network, such as a WI-FI.

Any suitable network and any suitable communication interface 1360 may be used. For example, computing device 1310 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, one or more portions of controller 1300 or computing device 1310 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof. Computing device 1310 may include any suitable communication interface 1360 for any of these networks, where appropriate.

The computing device 1310 may include a bus 1370. The bus 1370 can include hardware, software, or both that couples components of computing device 1310 to each other. For example, bus 1370 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

The computing device 1310 may be implemented as a super computer or a plurality of computing devices linked together, such as a high performance computing cloud, a cluster, or a large computer network. The computing device 1310 may be in communication with the super computer or plurality of computing devices linked together, either directly or indirectly, to provide probe light data, pump light data, images, and the like thereto. It should be appreciated that any of the examples of acts described herein, such as in the method 100 may be initiated, directed, or performed by and/or at the computing device 1310.

While various aspects and embodiments have been disclosed herein, other aspects and embodiments are contemplated. The various aspects and embodiments disclosed herein are for purposes of illustration and are not intended to be limiting.

1. A method for determining a thermal property of a material sample, the method comprising:
a) illuminating a surface of the material sample that has a reflective material disposed thereon with a pump light from a pump light source and a probe light of a probe light source at a plurality of locations on the surface;
b) modulating an intensity of the pump light at an initial modulation frequency;
c) detecting reflected light from the reflective material at a photodetector, over a duration, responsive to reflected light induced via the probe light from the probe light source;
d) altering the initial modulation frequency of the pump light to an altered modulation frequency;
e) performing acts a)-d) at the altered modulation frequency; and
f) determining the thermal property at least partially based on the reflected light.

2. The method of claim 1 wherein modulating an intensity of the pump light at an initial modulation frequency includes modulating the intensity of the pump light in a sinusoidal pattern of increasing and decreasing intensities.

3. The method of claim 1 wherein the altered modulation frequency includes a higher or lower frequency than the initial modulation frequency.

4. The method of claim 1 wherein determining the thermal property partially based on the reflected light includes determining a thermal conductivity and diffusivity of the material sample at each of the plurality of locations of the probe light.

5. The method of claim 1 wherein determining the thermal property at least partially based on the reflected light includes:
determining a phase delay in a pattern of intensity of reflected light with respect to the modulated intensity of the pump light corresponding thereto;
determining an amplitude of the pattern of intensity of reflected light received by the photodetector, wherein the pattern of reflected light corresponds to a phase delayed signal compared to the modulated intensity of the pump light corresponding thereto; and
determining one or more of a thermal conductivity, thermal diffusivity, or a Kapitza resistance of the material sample at a plurality of locations thereon by solving the heat equation at each of the plurality of locations.

6. The method of claim 5 wherein determining the thermal conductivity and diffusivity of the material sample at the plurality of locations thereon by solving the heat equation at each of the plurality of locations includes:
determining the amplitude and phase of each pattern of reflected light as a function of a corresponding modulation frequency of the pump light; and
using the amplitudes and phase delays of the patterns of reflected light, as a function of the corresponding modulation frequencies of the pump light and spatial distance of the probe light from the pump light, to solve for a thermal conductivity and a diffusivity of the material sample at each of the plurality of locations using the heat equation.

7. The method of claim 5 wherein determining one or more of a thermal conductivity, thermal diffusivity, and/or a Kapitza resistance of the material sample at a plurality of locations thereon by solving the heat equation at each of the plurality of locations is performed contemporaneously on a supercomputer for each of the plurality of locations.

8. The method of claim 1, further comprising identifying physical properties of the material at the plurality of locations based on the thermal properties at the plurality of locations.

9. The method of claim 8 wherein identifying physical properties of the material at the plurality of locations includes identifying grain boundaries in the material based on a phase delay of the reflected light at the plurality of locations.

10. The method of claim 1, further comprising translating the probe light to a different plurality of locations relative to the corresponding pump light and performing one or more of acts (b)-(g) at the different plurality of locations.

11. The method of claim 1 further comprising disposing the reflective material on the surface of the material sample that has been polished.

12. The method of claim 11 wherein disposing a reflective material on a surface of the material sample that has been polished includes disposing a gold or titanium film on the surface of the material sample.

13. A system for determining a thermal property of a material sample, the system comprising:
an optical arrangement including a pump light source, a probe light source, and a photodetector, wherein the probe light source is configured to emit probe light and the pump light source is configured to emit pump light onto a reflective material disposed on a sample; and
at least one controller operably coupled to the optical arrangement, wherein the controller is configured to:
direct the probe light source to simultaneously emit the probe light to a first plurality of locations;
direct the pump light source to simultaneously emit the pump light to a second plurality of locations corresponding to the first plurality of locations and modulate an intensity of the pump light according to a selected frequency;
receive electrical signals from the photodetector corresponding to reflected light detected at the photodetector; and
determine the thermal property partially based on the reflected light detected at the photodetector.

14. The system of claim 13 wherein the photodetector includes a lock-in camera.

15. The system of claim 13 wherein pump light source includes a digital light processing projector.

16. The system of claim 13 wherein the probe light source includes a digital light processing projector.

17. The system of claim 13 wherein the pump light includes a red laser light and the probe light includes a green laser light.

18. The system of claim 13 wherein the optical arrangement includes one or more of:
a polarizing beam splitter disposed between the probe light source and the photodetector;
a dichroic mirror disposed between the pump light source and the probe light source; or
a quarter wave plate disposed between the probe light source and the material sample.

19. The system of claim 13 wherein the at least one controller is configured to determine the thermal property partially based on the reflected light detected at the photodetector by:
determining a phase delay in a pattern of intensity of reflected light with respect to a modulated intensity of the pump light corresponding thereto;
determining an amplitude of the pattern of reflected light received by the photodetector, wherein the pattern of reflected light corresponds to a phase delayed signal compared to the modulated intensity of the pump light corresponding thereto; and
determining one or more of a thermal conductivity, thermal diffusivity, or a Kapitza resistance of the material sample at a plurality of locations thereon by solving the heat equation at each of the plurality of locations.

20. The system of claim 13 further comprising identifying grain boundaries in the material sample based on a phase delay of the reflected light at the plurality of locations.
